(19) United States
(12) Patent Application Publication
(10) Pub. No.: US 2025/0196090 A1
(43) Pub. Date: Jun. 19, 2025

(54) Inductive heating with metamaterial susceptors for chemical reactor systems

(71) Applicant: The Board of Trustees of the Leland Stanford Junior University, Stanford, CA (US)

(72) Inventors: Jonathan A. Fan, Los Altos, CA (US); Juan M. Rivas Davila, Palo Alto, CA (US); Calvin Lin, Stanford, CA (US)

(21) Appl. No.: 18/843,616

(22) PCT Filed: Mar. 13, 2023
(86) PCT No.: PCT/US2023/015132

§ 371 Date: Sep. 3, 2024

Related U.S. Application Data
(60) Provisional application No. 63/318,885, filed on Mar. 11, 2022.
(60) Provisional application No. 63/407,320, filed on Sep. 16, 2022.

(51) Int. Cl. B01J 19/32; B01J 6/00

(52) U.S. Cl. CPC B01J 19/32; B01J 6/008; B01J 2208/00203; B01J 2208/00469; B01J 2219/32286; B01J 2219/32408

(57) ABSTRACT

A chemical reactor for inductive heating has a non-conductive reactor wall (104) defining an interior (106) of the reactor, a conductive electromagnetic metamaterial susceptor (102) having an open cell 3D lattice structure distributed throughout a volumetric region within the interior of the reactor, electromagnetic coils (100) surrounding the susceptor, and a power supply (116) connected to the electromagnetic coils and adapted to produce AC electrical power at a predetermined operating frequency, thereby generating an electromagnetic field having a predetermined wavelength causing inductive heating of the susceptor. The susceptor has a predetermined effective AC conductivity response Gefr as a predetermined function of position within the volumetric region at the predetermined operating frequency.

### FIELD OF THE INVENTION

The present invention relates generally to devices and methods for inductive heating. More specifically, it relates to techniques for inductive heating in chemical reactors.

### BACKGROUND OF THE INVENTION

The volumetric heating of fluids (i.e., gases and liquids) to high temperatures is the foundation of many heating, energy, and chemical reaction systems that involve elevated processing temperatures or endothermic heat requirements.

The applications widely range from the processing of gas feedstocks for chemical production and the selective capture/release of gases (e.g., CO₂, SO₂) to temperature control in electrochemical cells and the heating of gases in engines and turbines.

The predominant method for generating high grade, high temperature heat in such systems is the combustion of carbonaceous fuels such as methane and propane, which leads to the generation of carbon dioxide.

For many reactor configurations, heating is performed exterior to the reactor and heat transfers through the reactor walls or through heat exchangers within the reactor. These methods suffer from inefficiencies that arise from only a fraction of heat transferring into the reactor interior and the need for large temperature gradients within the reactor walls, and they suffer from high heat resistance due to limitations in heat transfer through the volume of the reactor interior. In addition, they feature limited heat transfer fluxes, which is a practical bottleneck in reducing the residence times and reactor sizes for many applications.

There exist various heating methods based on electricity. For DC heating, concepts are mostly based on heating of a one-dimensional object, serving as an electrical heater, to generate heat. These one-dimensional objects can be configured into two-dimensional or quasi-three-dimensional objects, as in the case of a heating jacket. These concepts suffer from limitations in heat transfer to a three-dimensional volume. For example, metal-based tubular reactors that are directly heated with electricity require small cross-sectional dimensions to effective transfer heat to the tube volume. Also, direct resistive heating of three-dimensional objects has limits in reliable electrical contact and total power dissipation.

Methods based on high frequency electric field heating, such as those utilizing capacitive transducers, are limited in power by the electrical breakdown of the heating medium. Microwave technologies using standard microwave sources, such as magnetrons, do not efficiently convert DC electricity to microwaves, are limited to reactor configurations serving as microwave cavities, and are challenging to scale up due to the relatively small wavelength of microwaves, which presents challenges in hot spot management.

Inductive magnetic heating has also been explored, in various configurations. Most commonly, the inductive heating is performed using a susceptor built into the reactor wall, made from a conductive material such as graphite. Applications include the heating of refractory materials such as kiln furniture. In these concepts, heat is transferred from the susceptor to the media being heated.

Inductive heating has been applied to the magnetic hysteresis heating of magnetic particles for small scale reactors. For example, “Method for carrying out oxidation reactions using inductively heating medium” U.S. Pat. No. 8,569,526, and “Method for carrying out chemical reactions with the air of an inductively heated heating medium” U.S. Pat. No. 8,871,964 specify a magnetic induction frequency range of 1 to 100 kHz and are limited to magnetic heating susceptors with sizes between 1 and 1000 nm. The use of such nanosize susceptors at high temperatures is problematic because at high temperatures, the materials will decompose due to corrosion, oxidation, and material diffusion effects. Attempts to use magnetic nanoparticles for methane steam reforming, for example, displayed changes in particle size on the order of tens of nanometers after heating for tens of hours, which would completely change the magnetic permeability properties of the magnetic nanoparticles.

Inductive heating of metallic monoliths within a reactor are disclosed in “Induction heating of endothermic reactions” US20180243711, which discloses the possibility of using inductive coils to heat ferrous solid materials in the form of monoliths. This publication explicitly cites inductive heating regimes which has limited heating efficiency. It is also limited to ferromagnetic heating susceptors, and it does not teach how to achieve a desired heating profile or heating efficiency.

There are inductive heating schemes based on mesh-like susceptors for volumetric heating. “Induction-heated reactors for gas phase catalyzed reactions” U.S. Pat. No. 7,070,743 describes the inductive heating of a platinum mesh to produce hydrogen cyanide. In this publication, the mesh has random morphology, cannot provide locally uniform heating without hot spots, cannot extend to uniform volumetric heating, is intrinsically low efficiency, cannot be over 90% efficiency based on the example configurations, and is limited to hydrogen cyanide production.

“Catalytic assembly comprising a micrometric ferromagnetic material and use of said assembly for heterogeneous catalysis reactions” WO2021053307 describes the use of inductive heating on stainless steel wool. The system is exclusively a random arrangement of stainless-steel fibers, cannot yield uniform volumetric heating, cannot yield locally uniform heating without hot spots, is limited to stainless steel, and cannot extend to very high temperatures over 600 C. Additionally, it does not teach how to improve heating efficiency or achieve uniformity of heating.

“Catalytic converter system with control and methods for use therewith” U.S. Pat. No. 9,657,622 discusses the incorporation of conductive particles or wires within a catalytic converter that can be inductively heated. This concept is limited to catalytic converters and utilization of non-touching particles/wires.

“Inductively heated microchannel reactor” U.S. Pat. No. 10,207,241 applies inductive heating to a set of microchannels, which are subject to operational issues such as clogging and capital costs.

Another related patent is titled “Method for carrying out oxidation reactions using inductively heating medium” U.S. Pat. No. 8,569,526. However, it specifies a magnetic induction frequency range of 1 to 100 kHz and is limited to magnetic heating susceptors with sizes between 1 and 1000 nm.

“Method for carrying out chemical reactions with the air of an inductively heated heating medium” U.S. Pat. No. 8,871,964 is primarily concerned with flow chemistries and the use of discrete nanoscale heating susceptors with a magnetic induction frequency range of 1 to 100 kHz.

### SUMMARY OF THE INVENTION

Disclosed herein is a class of high temperature reactors that use inductive heating coupled to a conductive volumetric open cellular structured susceptor (i.e., a “mesh” susceptor) to heat and control the temperature within the reactor. The mesh generally comprises interconnected conductive elements. For a mesh comprising densely packed interconnected elements, it can be electrically characterized as having an effective conductivity. This conductivity may be spatially uniform, in the case of a uniform or random mesh, or be spatially inhomogeneous, in the case of a mesh made from unusually shaped elements or specified to support an unusual function (i.e., a customized temperature profile).

The concept applies to a broad range of chemical reactor configurations including reactors operating either in a fixed bed mode, a moving bed mode, a fluidized bed mode, as a riser, downer, rotary kiln, or membrane reactor. In all cases, the reactor wall comprises mostly or exclusively of a non-conductive material such as plastic, glass, or a refractory ceramic.

Electromagnetic coils surrounding the reactor tubes heat the mesh susceptor within the system.

This concept extends to non-magnetic susceptors and to magnetic susceptors operating above the Curie temperature, to volumetric heating profiles that are customizable based on susceptor geometry, and to susceptor geometries that explicitly eliminate local temperature hot spots.

The present techniques for inductive heating offers many advantages compared to conventional heating methods. A metamaterial mesh susceptor can be tailored to support electrically conductive properties that enable high efficiency (i.e., selective heating of the susceptor relative to heating of the inductive coil) and volumetric inductive heating within the entire vessel volume with no requirement of a heat transfer fluid. With proper design and optimization, the system can enable conversion of electricity to heat within the reactor with efficiencies over 90%.

The present techniques for inductive heating eliminates the need to provide heat through the reactor walls, reducing the temperature at the outer reactor wall surface and the temperature gradient within the wall. This not only reduces mechanical stresses due to thermal expansion within the reactor wall, it also allows the reactor to operate at higher temperatures compared to conventional heating. The reason is because for conventional heating, heat is delivered through the reactor wall and the temperature at the outer surface of the reactor wall is the highest temperature section of the system. This temperature is higher than the temperature in the reactor interior, as heat transfers to the reactor by a thermal gradient. With inductive heating, no such temperature gradient is required and that reactor interior can be inductively heated to the maximum temperature tolerated by the reactor wall. Conductive heat transfer between the reactor wall and susceptor can also be tailored and minimized by reducing the area of physical contacts between the wall and susceptor.

The present techniques for inductive heating enable volumetric heating, as opposed to heating mediated by a one-dimensional wire or two-dimensional heating jacket, improving the transfer of heat from the susceptor to reactant or catalyst. The heating profile can be customized based on the detailed susceptor design, producing heating profiles ranging from volumetrically uniform to spatially dependent. Moreover, the capital costs are modest because the use of inductive heating eliminates the need for bulky and costly heat exchangers and other equipment associated with heating by combustion, and the cost of power electronics required for inductive heating are modest.

The use of a volumetric mesh susceptor also offers advantages beyond heating efficiency and tailored volumetric heating profile. First, it can be tailored to support large void fraction, above 95% and in some cases above 99%, which minimizes the pressure drop of fluids flowing through the reactor. Second, the mesh susceptor can be designed and implemented to have large surface areas, particularly in the case where the mesh comprises microscale material elements or multi-scalar materials. Large surface area is compatible with large void fraction when the susceptor comprises small features with large surface area to volume ratios. Third, the mesh susceptor can be relatively tolerant to thermal expansion, in that it does not necessarily need to be mechanically stiff. Fourth, the susceptor can serve as the heating element, be the catalyst material itself, or a combination of both.

The use of magnetic induction with power electronic circuits for heating also offers new regimes of volumetric heating with time dependence, for example, heating of the susceptor with periodic pulses, heating the susceptor with a deterministic continuous time-varying waveform, and heating of the susceptor with a power that is specified by temperature measurements and feedback. The speed for which time-dependent heating can be performed is limited in part by the frequency of power electronics. For example, power electronics operating at 1 MHz can in principle produce resolved pulses with microsecond resolution. Other factors including the quality factor of the power electronics system and inductive coil and the presence of other reactor structures exhibiting capacitive and inductive behavior will influence and limit temporal heat resolution. Time varying heating of a volumetric susceptor can enable enhanced process control and also impact the products of the reaction when the timescale of the pulses is on the order of or less than the time scales for mass transfer, heat transfer, and kinetics involving the reaction.

In one aspect, the invention provides a high temperature reactor comprising: a reactor wall defining an interior of the reactor; a conductive susceptor composed of interconnected conductive elements distributed throughout a volumetric region within the interior of the reactor and adapted to heat the volumetric region; electromagnetic coils surrounding the conductive susceptor and adapted to produce an electromagnetic field that inductively couples to the conductive susceptor; and a power supply connected to the electromagnetic coils and adapted to produce AC electrical power at a predetermined operating frequency.

Preferably, spatial variations within the conductive susceptor (i.e., size scale of and spacing between the interconnected conductive elements) are substantially smaller than the free space wavelength of the electromagnetic field. In implementations involving reactors that are less than 4 inches or 2 inches in diameter, the predetermined operating frequency is preferably above 1 MHz. In implementations involving large reactors operating at high powers, the operating frequencies may be as low as 60 Hz.

The interconnected conductive elements may be arranged in an ordered structure or a disordered structure. The interconnected conductive elements are preferably densely packed.

The conductive susceptor may have spatially uniform effective conductivity or spatially inhomogeneous effective conductivity.

In various embodiments, the interconnected conductive elements may form a microwire mesh, metal wool, metal felt, regular metal mesh, metal pipes, tubes, or baffles. The reactor wall may be composed mostly of a non-conductive material such as plastic, glass, or a refractory ceramic. The reactor wall may contain conductive inclusions to improve properties such as strength, in a manner where the inclusions do not couple to the AC magnetic field from the coil.

In another aspect, the invention provides a chemical reactor for inductive heating, the chemical reactor comprising: a) a reactor wall defining an interior of the reactor, wherein the reactor wall is composed substantially of a non-conductive material; b) a susceptor composed of a conductive electromagnetic metamaterial; wherein the susceptor has interconnected conductive elements in an open cell 3D lattice structure; wherein the susceptor is distributed throughout a volumetric region within the interior of the reactor; c) electromagnetic coils surrounding the susceptor and adapted to produce an electromagnetic field that inductively couples to the susceptor; d) a power supply connected to the electromagnetic coils and adapted to produce AC electrical power at a predetermined operating frequency, thereby generating the electromagnetic field having a predetermined wavelength causing inductive heating of the susceptor; wherein susceptor has a predetermined effective AC conductivity response as a predetermined function of position within the volumetric region at the predetermined operational wavelength. In some embodiments, there are multiple distinct susceptors distributed throughout multiple volumetric regions within the interior of the reactor. In some embodiments, the electromagnetic coil has a length that is at most 1/10 of the predetermined operational wavelength.

Preferably, the effective AC conductivity is a predetermined function of position within the volumetric region. For example, the predetermined function of position may be a function of radial position within a cylindrical region, a function of axial position within a cylindrical region, or a function of axial and radial positions within a cylindrical region. The predetermined function of position may be selected to produce spatially uniform heating within the volumetric region. The predetermined function of position may be a constant function of position or a variable function of position.

Preferably, the predetermined function of position and predetermined operating frequency are selected based on a predetermined diameter of the chemical reactor in order to optimize the desired heating profile (uniform or otherwise) and efficiency. Additionally, the effective AC electrical conductivity can be anisotropic, and in the case of a cylindrical susceptor, it can have different profiles along the radial and azimuthal directions. In this manner, the effective thermal conductivity properties of the susceptor can be tailored along the radial and azimuthal directions. As heating is dependent on azimuthal electrical conductivity, the radial electric conductivity can be enhanced in a manner that leads to enhanced radial thermal conductivity, improving heating uniformity within the reactor.

In some embodiments, the susceptor has thickness within a factor of 10, or more preferably a factor of 3, of a skin depth δ of penetration of the magnetic fields within the susceptor at the predetermined operational frequency.

In some embodiments, the predetermined diameter of the volumetric region is within a factor of 10, or more preferably, a factor of 3, of a skin depth δ of penetration of the magnetic fields within the susceptor at the predetermined operational frequency.

In some embodiments, the effective AC conductivity is a predetermined constant function of position within the volumetric region, and wherein the product of the predetermined diameter of the volumetric region and the predetermined operational frequency is within a factor of 10, or more preferably, a factor of 3, of the reciprocal of the square of the predetermined diameter of the volumetric region.

The open cell 3D lattice structure may be, for example, a random mesh, foam, or ordered 3D-printed lattice.

### BRIEF DESCRIPTION OF THE DRAWINGS

FIG. 1A is a schematic diagram of an open-cell metamaterial susceptor and associated effective conductivity response.

FIG. 1B is a schematic diagram contrasting a conventional heating technique (left) with an embodiment of the present invention (right) that uses inductive heating.

FIG. 2A is a graph of power vs frequency for a susceptor with uniform effective conductivity, showing distinct regimes of inductive heating depending on comparative sizes of the skin depth and the reactor dimension.

FIG. 2B is a graph showing AC resistance as a function of frequency for susceptors with different effective conductivities.

FIGS. 3A, 3B, 3C, 3D are graphs illustrating experimental analysis of inductive heating of mesh susceptors made of various materials.

FIGS. 4A, 4B, 4C show heating profiles in a susceptor with uniform conductivity, illustrating three regimes where skin depth δ is much larger than, on the order of, and much less than the reactor radius R, respectively.

FIGS. 4D, 4E, 4F, 4G, 4H, 4I, 4J, 4K show graphs of power density vs radial distance from the axis for various frequencies.

FIG. 5A is a schematic diagram illustrating a cylindrical susceptor with non-uniform effective conductivity.

FIGS. 5B, 5C, 5D are graphs of effective conductivity vs radial distance and corresponding heating vs radial distance for various susceptors with non-uniform effective conductivities.

FIG. 5E is a three-dimensional cross-sectional rendering of a cylindrical susceptor.

FIG. 5F is a two-dimensional cross-sectional view of the susceptor of FIG. 5E, where the horizontal axis is radial position and vertical axis is axial position.

FIG. 5G illustrates simulated power density for a susceptor with two distinct effective inner and outer shell skin depths (δ), showing power density as a function of radial position for inner and outer shells of the susceptor.

FIGS. 6A, 6B, 6C illustrate steps for fabrication of a monolith susceptor with chemical functionality.

FIG. 7A is a cross-sectional diagram illustrating a cylindrical susceptor having continuous effective conductivity profile and an air core.

FIG. 7B is a graph of the effective conductivity as a function of radius for the susceptor of FIG. 7A.

FIG. 7C are heating profiles at five different frequencies for the susceptor of FIG. 7A.

### DETAILED DESCRIPTION

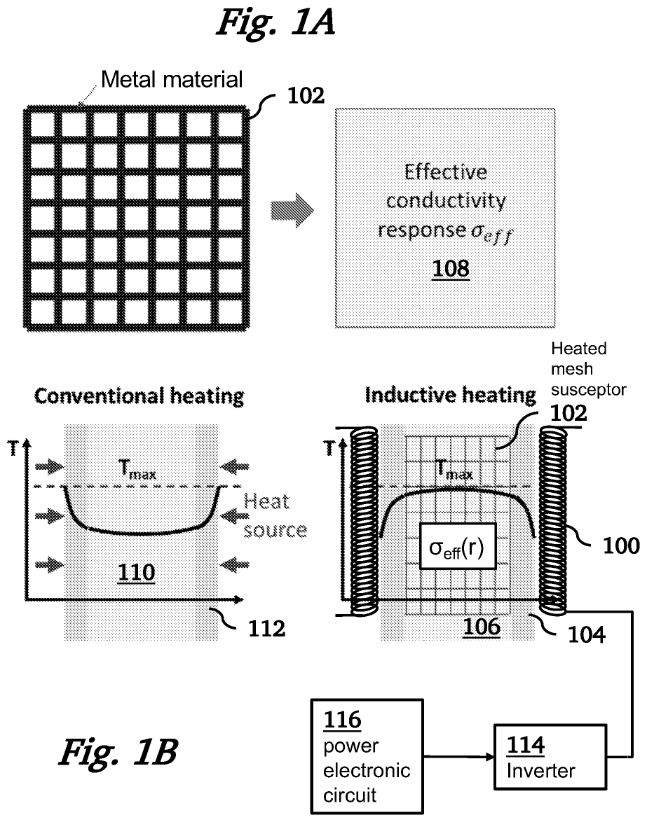

As illustrated in FIG. 1A and FIG. 1B, an embodiment of the present invention provides a high temperature reactor that uses inductive heating using coils 100 inductively coupled to a volumetric conductive open-cell metamaterial (i.e., “mesh”) susceptor 102 to heat and control the temperature throughout the volume 106 inside the reactor walls 104. The metamaterial susceptor 102 generally comprises interconnected conductive elements. For a metamaterial susceptor comprising densely packed interconnected elements, it can be electrically and electromagnetically characterized as having an effective conductivity response 108. This conductivity may be spatially uniform, in the case of a uniform or random metamaterial susceptor, or be spatially inhomogeneous, in the case of a metamaterial susceptor made from unusually shaped elements or specified to support a desired function (i.e., a customized temperature profile).

The concept applies to a broad range of chemical reactor configurations including reactors operating either in a fixed bed mode, a moving bed mode, a fluidized bed mode, as a riser, downer, rotary kiln, or membrane reactor. In all cases, the reactor wall 104 is mostly or exclusively made of a non-conductive material such as plastic, glass, or a refractory ceramic. Electromagnetic coils 100 surrounding the reactor outside the walls 104 heat the mesh susceptor 102 within the volume 106 within the reactor.

The individual elements within the metamaterial susceptor 102 feature diameters that range from one micron, in the case of a microwire mesh, to a meter in dimeter, in the case of a mesh that comprises a network of metal pipes or baffles. The concept can be adapted to reactor diameters ranging from one centimeter to ten meters or larger (i.e., from small micro-reactors to large commercial reactors) and be adapted to inductive heating frequencies ranging from 60 Hz to 50 MHz.

The metamaterial (“mesh”) susceptor 102 is composed of interconnected conductive elements that form an inhomogeneous volumetric conductive system that can be efficiently heated by induction heating. Densely packed meshes can be modeled as supporting an effective conductivity response 108, which can be tailored by the detailed mesh geometry and is used for electromagnetic modeling and configuring the system to achieve efficient and uniform volumetric heating. The effective electrical conductivity response can be tailored to be either isotropic or anisotropic. The metamaterial susceptor will also support an effective thermal conductivity response that can be co-designed together with the effective electrical conductivity response. FIG. 1B contrasts an embodiment of the present invention with a conventionally heated reactor, specifically micro-and modular-scale reactor, whose interior 110 is heated via heat conduction through the reactor walls 112. The highest temperatures are at the outer surfaces of the walls 112 and the temperature within the reactor interior 110 is less than Tₘₐₓ, which is the maximum temperature tolerated by the reactor wall 112. In contrast, a reactor inductively heated with a mesh susceptor 102 has a temperature profile that is maximum within the reactor interior and lower at the reactor walls 104. Using inductive heating, the temperature within the reactor interior 106 can approach Tₘₐₓ.

The mesh susceptor 102 can be manufactured and configured in various ways. For example, the mesh susceptor 102 can comprise a randomly ordered ensemble of conductive elements such as metal wool, metal felt, and percolated networks of interconnected conductive structures. It can comprise a deterministic ordered array of conductive elements made from the shaping and bonding of these elements, such as a regular metal mesh. It can be fabricated using additive manufacturing, from which an interconnected conductive structure can be fabricated to have tailored three-dimensional shape and made from one or multiple conductive materials. It can be printed or casted from a slurry that comprises in part percolating conductive microparticles, support material, and catalytic material. It can comprise metal elements in existing reactors, such as preexisting baffles and metallic tubes, which already form a three-dimensional network of conductive media or can be modified to form a three-dimensional network. This repurposing of elements in existing reactors will lead to significant cost savings and help streamline the translation of these concepts to existing technologies.

Using the concepts of the present invention, the mesh susceptor 102 is preferably designed using computational methods to achieve desired design metrics, such as a desired surface area, volumetric filling fraction, or volumetric temperature profile. It can also be designed to achieve functional properties beyond heating, such as desired mechanical property, and fluidic and/or particle flow properties including desired mixing of fluid and particles for which, the mesh susceptor can be configured in various designs, e.g., as motionless/static mixers of any geometries such as plate-type and helical static mixers.

The mesh susceptor 102 can comprise a wide range of materials that are application specific. For heating at high temperatures and potentially corrosive or oxidizing environments, materials including stainless steels, nickel superalloys, iron superalloys, nichrome, and kanthal can be used. Specific chemical properties can also be incorporated, such as catalytic properties. For example, for steam methane reforming, the mesh susceptor can be made from a reforming catalyst such as nickel.

The mesh susceptor 102 can be embedded into a solid material, such as a mechanically rigid ceramic piece, to provide uniform heat to that piece. The mesh susceptor 102 can also simultaneously serve as a susceptor and mechanical support for particles, holding into place material containing sorbents or catalyst material. In this manner, mesh-held particles serve as a fixed bed reactor with integrated heating capability.

For the induction frequencies of interest, the spatial variations within a metal mesh (i.e., size scale of and spacing between metal wires or pipes) are much smaller than the free space wavelength of the electromagnetic field, which is 30 kilometers at 10 kilohertz and 300 meters at 1 megahertz. In this limit, a dense metal mesh can be properly and rigorously modeled as a uniform medium with an effective permittivity ε_{eff} or effective conductivity σ_{eff} that depends on the detailed mesh wire geometry and material composition. The Drude model provides a framework for relating permittivity and conductivity.

Various models may be used to perform this effective medium homogenization of conductivity. A metal mesh comprising periodic interconnecting conducting wires in the perfect electrical conductor limit can be treated as a Drude-like electrical metamaterial with a permittivity featuring radio frequency plasma frequencies¹, thereby exhibiting σ_{eff} values that are orders of magnitude smaller than those of conventional metals. For meshes comprising random inclusions, conducting wires with finite conductivities, and/or conductors with dispersive properties (i.e., function of frequency), effective conductivities can be calculated numerically.

This ability to tailor σ_{eff} based on the mesh geometry enables these mesh systems to have tailorable δ, which is the skin depth and is equal to \sqrt{2/(μ₀σ_{eff}ω)}, where ω is the angular frequency of the magnetic field used for induction. The skin depth is a representative length scale for electromagnetic wave penetration into a conductive medium, and it equals the length scale for which electromagnetic fields decay by a factor of 1/e.

To understand the impact of skin depth and effective conductivity on inductive heating efficiency and uniformity, we consider a cylindrical chemical reactor in the presence of an axially oriented magnetic field with magnitude B₀, though the analysis can readily generalize to chemical reactors with varying reactor layouts and magnetic field configurations. We will first consider the simple case of a cylindrical chemical reactor filled with a uniform and isotropic metamaterial susceptor, such that the susceptor fills a cylindrical volume and is characterized by a constant σ_{eff}. The induced currents J within the cylinder as a function of radial position r are proportional to:

$$J ∼ \frac{{B}_{0} ( 1 + i )}{δ} \frac{{J}_{1} ( ( 1 + i ) ( r / δ ) )}{{J}_{0} ( ( 1 + i ) ( a / δ ) )} \qquad Eq . 1$$

where a is the cylinder radius, J₀ and J₁ are the zeroth and first Bessel function, respectively, and i is equal to \sqrt{−1}. The power P dissipated by the mesh is calculated as

$$P = \frac{1}{2 {σ}_{eff}} \int {\vert J \vert}^{2} dV ,$$

and the power per cylinder length is proportional to

$${P}_{susceptor} ∼ ω {δ}^{2} {{B}_{0}^{2} ( a / δ )}^{2} Im \{ \frac{{J}_{2} ( ( 1 + i ) ( a / δ ) )}{{J}_{0} ( ( 1 + i ) ( a / δ ) )} \} \qquad Eq . 2$$

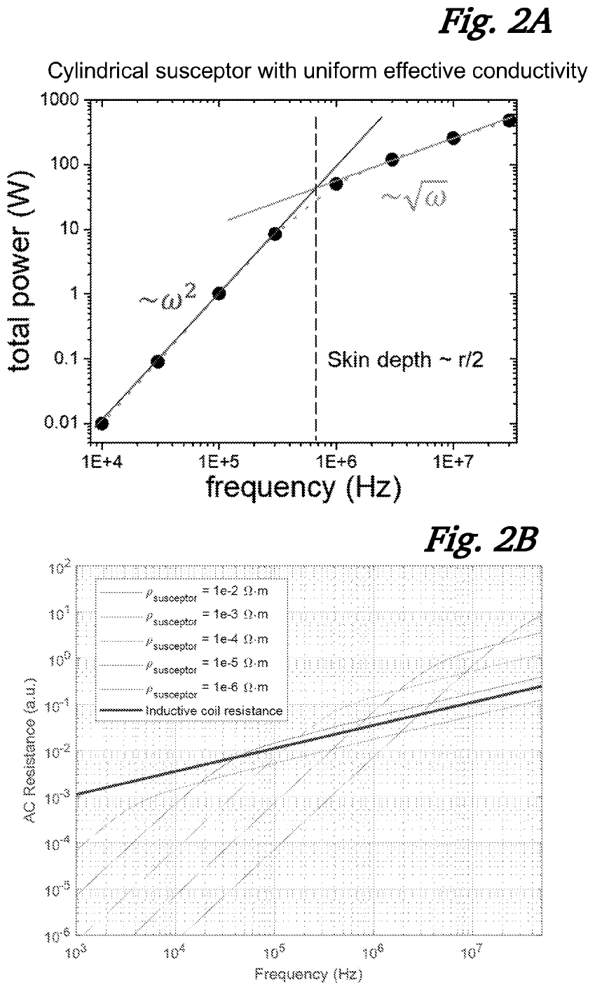

A plot of P_{susceptor} as a function of frequency for a susceptor with a/δ=2 in FIG. 2A shows distinct regimes of inductive heating when the skin depth is either much larger, on the order of, or smaller than, the reactor dimension.

When a/δ is on the order of or less than one or two, the currents induced in the mesh cylinder are volumetric and extend throughout the susceptor body (see Eq. 1). While the heating profile is non-uniform, the potential for the susceptor to support high effective radial thermal conduction can address the issue of temperature uniformity for applications requiring such a temperature profile. Note that as a/δ decreases, dissipated power scales as (a/δ)⁴ and the dissipated power and heating efficiency will reduce. As the term a/δ is proportional to \sqrt{ω}, dissipated power scales as ω².

When a/δ is much larger than one or two, the dissipated power is relatively large, however only the surface of the cylinder is heated because the AC magnetic field cannot fully penetrate the cylinder. In this regime, dissipated power scales as a/δ, or \sqrt{ω}.

The power dissipation within the cylindrical susceptor competes with power dissipation in the inductive coil itself. A typical helical coil has power dissipation P_{coil} that scales as \sqrt{ω}, which is due to a combination of Ohmic losses and proximity effects.

Based on the above analysis, one can determine how the frequencies ω and mesh σ_{eff} should be chosen to achieve differing regimes of inductive heating, as follows.

1) We first consider the regime of volumetric metamaterial susceptor heating with an induced current distribution spanning the susceptor width. This regime is particularly relevant in chemical reactors where thermal transport within the reactor is dominated by conductive and convective mechanisms. ω and σ_{eff} should be chosen so that a/δ is less than 2. The range of values cited here capture an intrinsic tradeoff between heating efficiency and heating uniformity: as a/δ decreases, the total dissipated power and heating efficiency decreases.

2) At temperature above approximately 700° C., thermal transport within the reactor becomes increasing dominated by radiation transport, which leads to equilibration of the internal reactor temperature even when it is inhomogeneously heated. For these systems, a/δ can take nearly any value, though the intrinsic tradeoff between heating efficiency and a/δ still exists. To ensure maximal heating efficiency, ω and σ_{eff} should be chosen so that a/δ is greater than two.

3) Heating efficiency is maximized when a/δ is, or exceeds, on the order of one or two. The increase in heating efficiency as a function of ω can be understood as follows: when a/δ is less than one or two, P_{susceptor} scales as ω whereas P_{coil} scales as \sqrt{ω}. When a/δ is greater than one or two, increasing ω does not improve heating efficiency because both P_{susceptor} and P_{coil} scale as \sqrt{ω}.

To further visualize these trends and design rules, plots of AC resistances as a function of frequency for mesh susceptors (Z_{susceptor}) featuring differing effective conductivities are plotted in FIG. 2B. The AC resistance of a representative helical coil is also shown (bold line). The coil is made from quarter inch thick copper, has a diameter of 3 inches, a height of 6 inches, and a total of 6 turns, and the susceptor has a 1 inch diameter. The susceptor resistivity ρ_{susceptor} is inversely proportional to its effective conductivity. For a susceptor with a fixed conductivity value, the AC resistance scales as ω², rolls off when a/δ˜1, and then scales as \sqrt{ω} at high frequencies. The plot of AC resistance for susceptors with different effective conductivities in FIG. 2B indicates that AC resistance generally increases with increasing ω, and that for a given operating ω, AC resistance is maximal when a/δ˜1. The AC resistance of a representative helical coil (Z_{coil}) is also shown in red (bold) and scales as \sqrt{ω} for all frequencies. With heating efficiency calculated as Z_{susceptor}/(Z_{susceptor}+Z_{coil}), we see that high (90% +) efficiency for this particular coil-susceptor configuration is possible only when the frequency is high (i.e., above 1 MHz) and the effective susceptor conductivity is tailored so that a/δ˜1 in the ˜1-100 MHz range.

An experimental characterization of the AC resistance properties of metal mesh susceptors made from metal wools, which comprise a random packing of interconnected microscale metal fibers. Metal wools are cheaply mass produced as they are used as abrasives and filters in automotive and industrial industries.

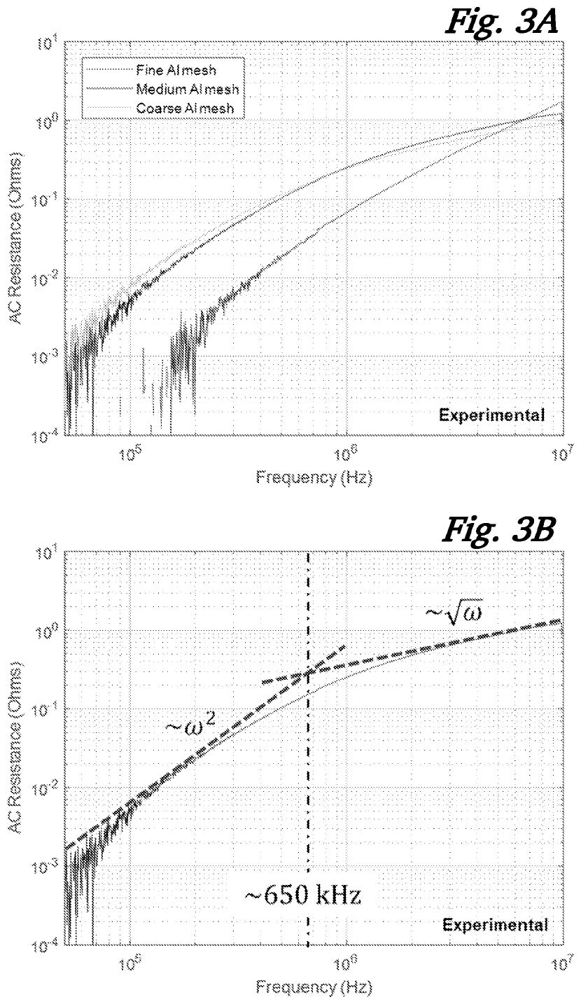

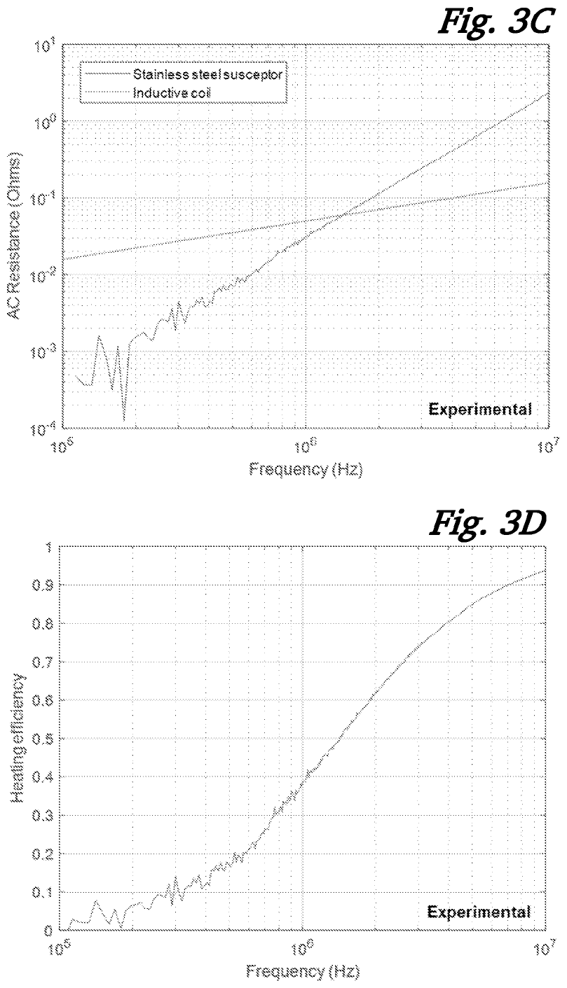

FIGS. 3A, 3B, 3C, 3D illustrate experimental analysis of inductive heating of a mesh susceptor with a helical coil. FIG. 3A shows experimental AC resistance of cylindrical aluminum mesh susceptors made from aluminum wool with differing fiber thicknesses. FIG. 3B is a detailed plot of the AC resistance of aluminum wool with medium fiber thickness, showing different frequency scaling regimes that match well with theory. FIG. 3C shows AC resistance of a 316 stainless steel wool susceptor with fine fiber thickness, together with the AC resistance of a copper helical inductive coil. FIG. 3D shows efficiency as a function of frequency for the susceptor and inductive coil system featured in FIG. 3C.

More specifically, a summary of the AC impedances of aluminum wool susceptors is shown in FIG. 3A. Aluminum wool material with fine, medium, and coarse fiber thicknesses were packed into a 1″ diameter, 6″ long cylindrical reactor to form the susceptor. The AC resistance plots show that at low frequencies, all three susceptors have resistances that scales as ω², indicating they behave as cylinders featuring an effective conductivity. The susceptor made from fine aluminum wool has AC resistances that are relatively low compared to the other susceptors, indicating that its effective conductivity is less than the other samples. This trend is consistent with models that indicate the effective conductivity of a mesh increases with increasing fiber thickness¹.

A more detailed analysis of the AC resistance plot of the susceptor made from aluminum wool with a medium fiber thickness is shown in FIG. 3B and further reinforces that the mesh susceptor can be treated as an effective conductive medium. The low frequency AC resistance scales as ω² and the high frequency AC resistance scales as \sqrt{ω}, which is consistent with the theoretical trends presented previously for a cylindrical conducting susceptor. Deviations between the trend lines and experimental data are due in part to dispersion in the effective conductivity (i.e., conductivity is not constant and is a function of frequency). The experimental “crossover” frequency between the two different regimes, demarcated at ˜650 kHz, can be used to calculate ρ_{susceptor} to be 2e−4 Ohm-m, with the assumption that ρ_{susceptor} is independent of frequency.

The mesh susceptor can be made from a range of materials without loss of generality, and the AC resistance of a stainless steel wool susceptor is shown in FIG. 3C. The susceptor as shown is made from 316L stainless steel fibers with a fine fiber thickness, and it is packed into a 1″ diameter, 6″ long cylindrical reactor. As with the aluminum mesh susceptors, the stainless steel susceptor features an AC resistance that scales as ω² in the frequency regime where a/δ is much less than 1. The experimental impedance of an inductive copper coil with a 3″ inner diameter and 8 wounds, made from ¼″ diameter copper tubing, is also shown in the plot and scales as \sqrt{ω} at all frequencies. The crossover point between the coil and susceptor impedances represents the point where heating efficiency is 50%.

FIG. 3D shows the heating efficiency of the susceptor, using the data in FIG. 3c and the efficiency expression Z_{susceptor}/(Z_{susceptor}+Z_{coil}). For this susceptor and coil set, heating efficiency increases as a function of frequency and exceeds 90% at frequencies above 8 MHz.

Embodiments of the invention preferably employ a volumetric metamaterial susceptor in contact with a (gas or liquid) fluid. The metamaterial susceptor is inductively heated to produce a desired heating profile. The metamaterial itself has at least two length scales. The first is that of the reactor itself. The second length scale is the metamaterial unit cell, which ranges from tens of microns (in the small limit in metal felts) to millimeters (which is explored in experiments with 1-2 inch diameter reactors and 3D printing) to multiple centimeters (in the case where the reactors are really large and the susceptor itself includes relatively thick metal wires for mechanical stability). These unit cells connect as interconnected conductive elements to form an open cell, three-dimensional structure. The unit cells may be identical or vary in geometric shape as a function of position.

The collective properties of the metamaterial unit cells produce an effective homogenized metamaterial response, in particular electromagnetic, thermal, and mechanical properties corresponding to an effective AC conductivity (FIG. 1A), effective permeability, effective thermal conductivity, and effective elastic modulus, respectively. A more detailed discussion pertaining to the effective AC conductivity metamaterial response is provided below. These effective properties may be spatially uniform, in the case of a uniformly ordered (for example, uniform cubic mesh) or random metamaterial, or be spatially inhomogeneous and be a function of position. These electromagnetic, thermal, and mechanical properties are dependent on the detailed metamaterial structure and are deliberately specified through detailed microscopic element design.

The metamaterial susceptor 102 is positioned in a reactor vessel with walls 104 that comprise mostly or exclusively a non-conductive material such as plastic, glass, or a refractory ceramic, and it is heated using an electromagnetic coil 100 that is in proximity of or wound to enclose the volume 106 containing the susceptor 102. In a basic configuration, the susceptor 102 has a cylindrical form factor and is placed in a tube shaped reactor with electrically insulating walls 104, and a helical electromagnetic coil 100 surrounds the tube. For operation in a high-pressure environment, the vessel can be placed within a pressurized shell to enable high temperature, high pressure reactions. The coils 100 are driven by an inverter 114 and power electronic circuit 116. The frequency of the inverter 114 is set such that the coil length (metal used in the inductive coil 100) is equal to or less than λ/10, where λ is the free space wavelength of the electromagnetic wave associated with inverter frequency. This condition ensures the magnetic coil 100 does not serve as a radiator.

The metamaterial mesh susceptor 102 is composed of interconnected conductive elements that form an open cell volumetric system that can be efficiently heated by induction heating. These elements can be collectively treated as a metamaterial with effective electromagnetic, thermal, and mechanical properties that are tailored by the detailed three-dimensional geometry. In the case of electromagnetic properties, the metamaterial susceptor has an effective AC conductivity response that is tailored to achieve efficient heating of a tailored volumetric profile.

The concept can be adapted to vessel diameters ranging from one centimeter to ten meters and be adapted to inductive heating frequencies ranging from 60 Hz to 50 MHz. The choice of frequency and susceptor geometry is tailored to ensure high efficiency heating. For reactors with diameters on the order of ten or twenty centimeters or less, use of high induction heating frequencies on the order of or over 1 MHz maximizes heating efficiency and is required independently of susceptor geometry. For frequencies over 1 MHz and power levels below 50 or 200 kW, high efficiency solid state switches based on GaN or SiC are ideal. For reactors between 6 cm and 1 m, inductive heating frequencies between 50 to 60 Hz and 1 MHz can be used with more conventional power electronics, to power levels as high as 10 MW. For reactors on the order of a meter or greater, frequencies below 100 or 400 kHz can be used. Efficient, low frequency power electronics can also accommodate high powers of 10 kW to 10 MW power levels, and directly transformed AC currents can be used for exceptionally high power applications in the megawatt range.

The individual elements within the susceptor feature diameters that range from one micron, in the case of a microwire mesh, to a meter in dimeter, in the case of a network of metal pipes or rods. The porosity of the metamaterial, defined as a representative length scale for the pore openings in the open cell structure, can range from one micrometer to one meter. The susceptor can be realized using ferromagnetic or non-magnetic conductive materials and produce heating using either or a combination of hysteresis and Eddy current heating. The susceptors can be made from ferromagnetic material, though it generally does not need to be ferromagnetic.

The precise material composition of the susceptors depends on their application. For high temperature applications greater than 600 C, superalloy materials such as FeCr alloy (magnetic), titanium, graphite, and nickel superalloys (non-magnetic), as well as conductive ceramics such as SiSiC and SiC, are well suited. For temperatures below 600 C, the susceptor materials can be various stainless steels, aluminum, brass, or copper.

The temperature within the reactor can be controlled in multiple ways. First, the amount of power provided by the power electronic circuit 116, gas flow rate, and known energy consumption of a reaction can be computed and specified in an open loop in a manner that produces a desired steady state heating and temperature profile. Second, for susceptor material featuring a large variation in impedance as a function of temperature, as in the case for ferromagnetic susceptors (impedance variation below Curie temperature) or materials supporting strong electrical conductivity dependence as a function of temperature, the power electronic circuit can be specified to deliver power as a function of susceptor impedance. In the event where the susceptor impedance is a strong function of temperature and where uniform heating is desired for different temperatures, ultra-broadband impedance matching or use of impedance measurements to modulate power/voltage in a closed feedback loop can be utilized.

To scale up reactor volume to large scales, multiple few-inch-diameter tubular reactors each filled with susceptor can be used instead of a single large monolithic susceptor. For susceptors with uniform effective conductivity, these reactors are small enough such that the presence of large heating gradients will enhance conductive heat transfer and push the temperature profiles to be relatively uniform, despite the non-uniform heating profiles. It is also easier to additively manufacture smaller scale susceptor structures with these size scales, and the susceptor structures will not need to deal with large weight/mechanical forces on itself. In this scheme, the tubes are thermally insulated. In one embodiment, the tubes are sufficiently spread apart on the order of the tube diameter to minimize electromagnetic proximity effects between tubes, and in another embodiment, proximity effects between tubes are utilized to further tailor the heating profiles within each tube.

There are various pathways to manufacturing the susceptor. Large scale susceptors can be made by conductively connecting macroscopic metal rods, pipes, or wires together into a three-dimensional lattice. Small scale susceptors can be made from a disordered material, such as a metal wool, felt, or foam. A disordered susceptor system is susceptible to uncontrolled local variations in temperature and the presence of hot spots (i.e., there can be specific local metal junctures where the local temperature is high). These systems are therefore suitable for applications that have low to no sensitivity to such local temperature variations.

Susceptors tailored for vessels with small to modular form factors can also be manufactured using additive manufacturing, which enables the most precise specification of the detailed geometry, heating profile, structure profile, and thermal conductivity profile. Additive manufacturing has the benefit of enabling detailed control over the local geometric features within a susceptor involving junctions between multiple metallic elements, the local curvature of microscopic metallic elements, the precise cross-sectional area of the elements, and surface roughness. This control can minimize and mitigate the presence of unwanted local heating hotspots within the susceptor and practically enable susceptor configurations in which the effective AC conductivity varies as a function of position. Additionally, additive manufacturing enables the detailed specification of anisotropic lattice geometries with tailored electromagnetic, thermal, and fluidic properties as a function of radial, azimuthal, and axial position.

In preferred embodiments, the heating susceptor is be treated as a metamaterial and modeled as having an effective AC conductivity, σ_{eff}, and an effective permeability μ_{eff} (in the case of a magnetic material below its Curie temperature). This homogenization treatment of the volumetric susceptor enables a systematic and quantitative design procedure for specifying the heating efficiency and heating profile within the susceptor.

For susceptors with no σ_{eff} and μ_{eff} position dependence, σ_{eff} and μ_{eff} can be tailored to maximize inductive heating efficiency and uniformity for a given inductive heating frequency. Ideal σ_{eff} and μ_{eff} values are selected so that the susceptor skin depth δ for a cylindrical susceptor is approximately the radius of the cylinder. A cylindrical susceptor with uniform σ_{eff} and μ_{eff} will have a volumetric and non-uniform heating profile, with a heating profile that goes as (J₁(kr))² where J₁ is the first order Bessel function, r is the radial distance from the axis of the cylinder, and k is the wavevector. However, for reactor systems with diameters on the order of a few inches or less and for susceptors featuring sufficiently high effective thermal conductivity, thermal conduction and convection can lead to much greater temperature uniformity. For applications where selective heating along the outer susceptor walls is preferred, σ_{eff} and μ_{eff} can be specified such that the susceptor skin depth δ is much less than the susceptor radius R.

With the skin depth and frequency ω in hand, we can directly compute the required effective conductivity and permeability from the “good conductor” skin depth formula:

δ=\sqrt{2/(μ_{eff}σ_{eff}ω)},

where ω is the angular frequency of the magnetic field. For a non-magnetic susceptor,

σ_{eff}=2/ωμ₀δ².

The susceptor effective conductivity is preferably selected such that the skin depth δ ranges from 10 times the reactor diameter 2R to 1/10 times the reactor diameter. For efficient volumetric heating, the skin depth δ should range from 3 times the reactor diameter to ⅓ times the reactor diameter. Note, if the conductivity of a conductor is too low, the cited formula does not apply, and skin depth δ will no longer scale with frequency. This “low conductivity limit” occurs when the effective conductivity is much less than 2πε_{eff}ω. For a 10 MHz frequency and free space permittivity, this effective conductivity threshold is on the order of 10⁻³ S/m. This sets a lower limit for effective conductivity in our analysis.

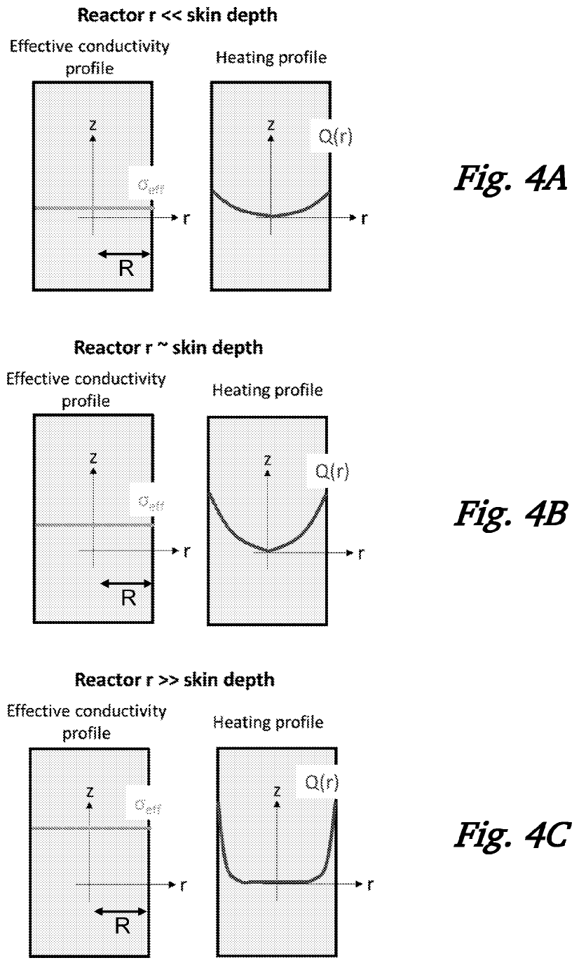

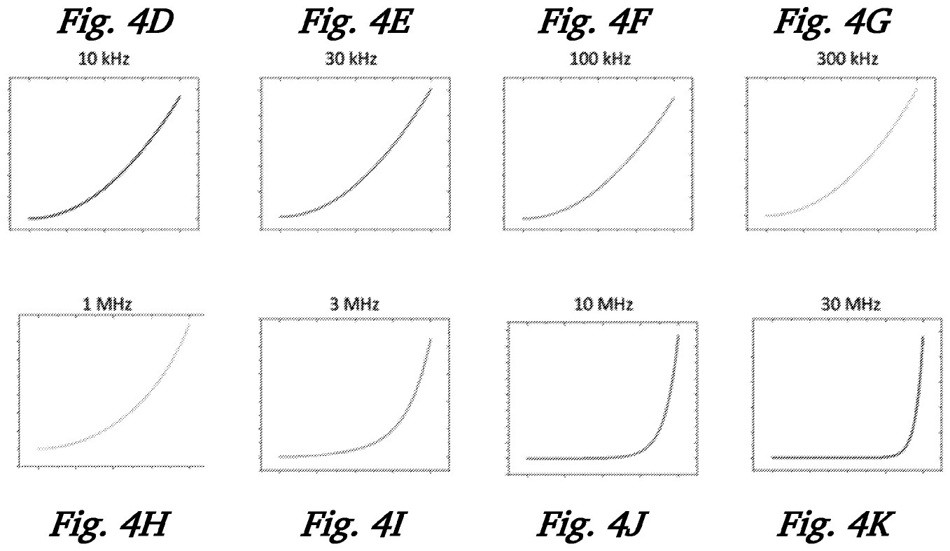

FIGS. 4A, 4B, 4C show heating profiles in a susceptor with uniform conductivity. Effective conductivity and heating profiles for three operating regimes are illustrated, where FIG. 4A shows the case where skin depth δ is much larger than the reactor radius R, FIG. 4B shows the case where skin depth δ is on the order of the reactor radius R; Skin depth δ is much larger than the reactor radius R, FIG. 4C shows the case where skin depth δ is much less than the reactor radius R. FIGS. 4D, 4E, 4F, 4G, 4H, 4I, 4J, 4K show power density vs radial distance from the axis for various frequencies in the case of a susceptor. For frequencies in which skin depth is much larger than the reactor radius, the heating profiles are consistently similar and span the full cylinder with a null at zero radius. Heating power increases as the square of frequency. For frequencies in which the skin depth is much smaller than the reactor radius, heating becomes increasing localized at the outer boundaries of the cylinder.

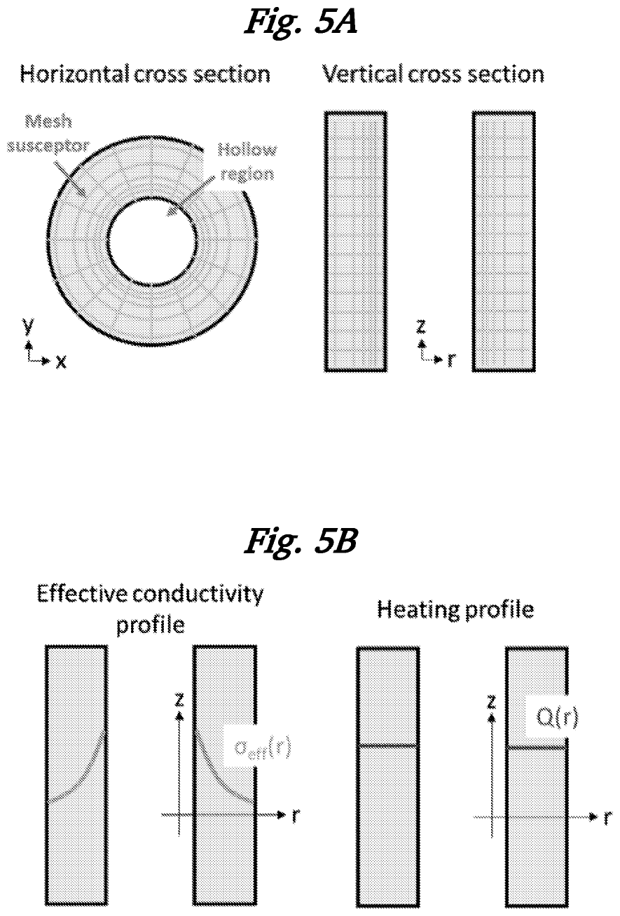

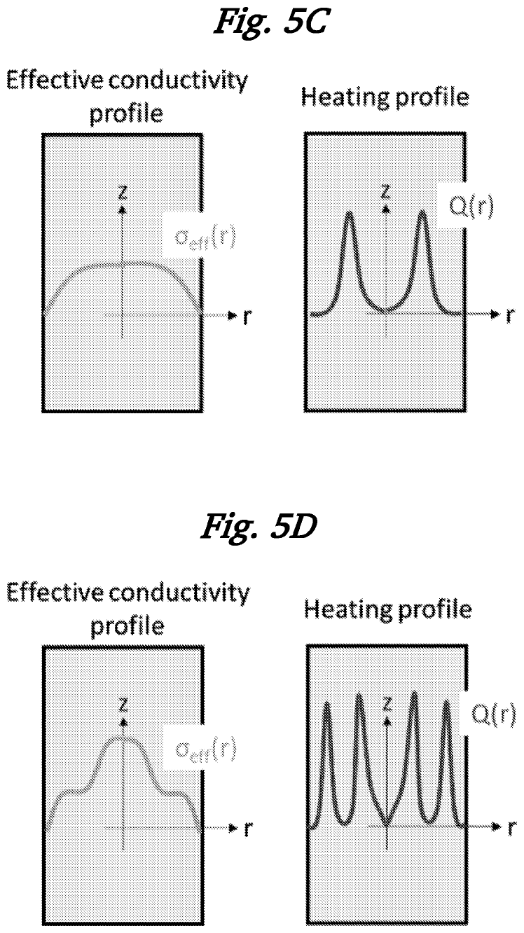

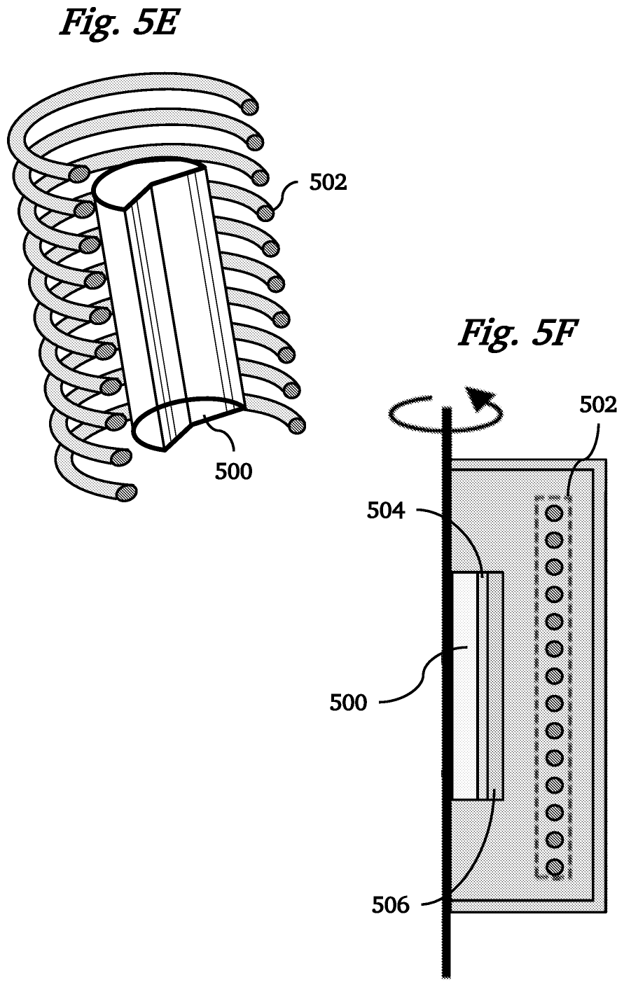

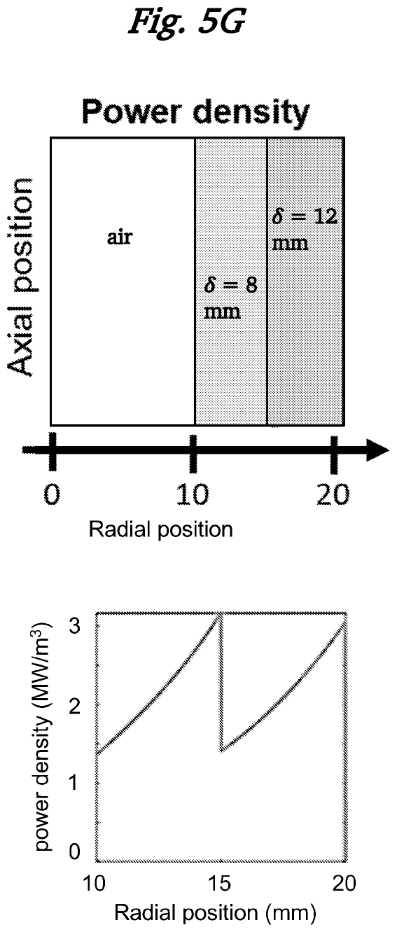

For susceptors with σ_{eff} and μ_{eff} position dependence, these values can be optimized and tailored as a function of radial position. FIGS. 5A, 5B, 5C, 5D Illustrate susceptors with non-uniform effective conductivities. FIG. 5A shows a donut-shaped cylindrical susceptor with a non-unform metamaterial geometrical layout that supposes a radial-dependent effective conductivity. FIG. 5B shows an effective conductivity profile that produces uniform, volumetric heating. FIG. 5C shows an effective conductivity profile of a cylindrical susceptor that produces targeted heating at a particular radial position. FIG. 5D shows an effective conductivity profile of a cylindrical susceptor that produces targeted heating at multiple radial positions.

Positional dependences in σ_{eff} and μ_{eff} are achieved by varying the microscale susceptor geometry as a function of position including the cell size, cell metal fill fraction, and metal element width (FIG. 5A). As an example, σ_{eff} can be specified to have a dependence of 1/rⁿ in a cylindrical configuration where n values from 1 to 5. The selection of n is tuned to reduce gradients in the heating profile or even invert the heating profile so that heating increases as the radial position in the cylinder decreases. As this type of conductivity profile leads to the conductivity taking unrealistically large values near the center of the cylinder, it does not apply to the susceptor center. This conductivity profile can directly apply to situations where the susceptor is donut-shaped (i.e., the susceptor core has been removed). A uniform volumetric heating profile in a donut-shaped reactor (FIG. 5B) can be specifically produced by solving the Helmholtz equation for induced currents such that |J(r)|²/2σ_{eff}(r) is constant as a function of r, where σ_{eff} is effective conductivity and r is radial position.

σ_{eff} and μ_{eff} can support more general position dependences that are optimized and tailored to produce different temperature zones as a function of position within the reactor, both axially and radially (FIGS. 5C, 5D). For example, it can be specified to produce a high temperature zone with tailorable width along the outer edges of the reactor and a low temperature zone with tailorable width at the center of the reactor. This can lead to new compact and energy efficient reactor modalities such as the support of methane reforming (high temperature and endothermic) and water gas shift reactions (low temperature and exothermic) in the same volume for hydrogen production. The susceptor can also be configured to provide uniform heating with different temperatures at two different axial positions. To solve for the proper σ_{eff} and μ_{eff} to achieve a desired heating profile, Helmholtz's equation for J (current) in the susceptor, which is a function of σ_{eff} and μ_{eff}, can be analyzed. σ_{eff} and μ_{eff} profiles that produce a desired J or heating profile are solved for using one of a number of optimization methods, such as the adjoint method or Newton's method.

Inductive heating of a cylindrical susceptor with an effective conductivity that varies as a function of radial position, with a helical coil, is illustrated in FIGS. 5E, 5F, 5G. Variation of the effective conductivity as a function of position enables customized heating profiles beyond the scope of susceptors with uniform effective conductivity. FIG. 5E is a three-dimensional cross-sectional rendering of a cylindrical susceptor 500 placed within a coil 502 approximated as a series of circular conductive loops. An AC current running through the coils produces an AC magnetic field that induces eddy currents in the susceptor. The susceptor comprises an air core and concentric rings with different AC conductivities. The air core is incorporated as no eddy current/heating is possible at zero radial position even if the core is conductive, and it can potentially be filled with an insulator to produce a donut-like reactor geometry. FIG. 5F is a two-dimensional cross-sectional view of the susceptor and coil system, where the horizontal axis is radial position and vertical axis is axial position. For this particular system, the susceptor cylinder has a total radius of 20 mm and has an air core with an inner 504 and outer 506 conductive shell. The coil supports an AC current of 1 MHz. FIG. 5G illustrates simulated power density for the susceptor with effective inner and outer shell skin depths (δ) shown. The plot of power density as a function of radial position shows a pattern supporting the same average power in both the inner and outer shells.

Embodiments include more generalized cylindrical susceptor concepts that comprise additional concentric shells, including an air core and three concentric shells. In a specific implementation, an air core has a radius of 10 mm, each shell has thickness of 5 mm, and the inductive heating frequency is 1 MHz. The outer shell skin depth is fixed to be 20 mm and the inner (layer 1) and middle (layer 2) skin depths are parametrically swept. A wide range of heating profiles can be achieved as the effective skin depths of each layer are modified. An appropriate combination of skin depths results in the heating profile being approximately uniform.

Embodiments include a cylindrical susceptor comprising an air core and seven conductive shells. In a specific implementation, an air core has a radius of 2.5 mm and each shell has a thickness of 2.5 mm. An optimization algorithm is used to iteratively modify the conductivity in a manner that improves the uniformity of power dissipation within the full susceptor. A final effective skin depths of shells 1 to 7 are 4.5/7.5/11/14.5/18/21.5/25 mm, which correspond to a total susceptor with an effective conductivity that scales as 1/r^{2.15}.

Embodiments include a cylindrical susceptor comprising an air core and a conductivity profile that continuously varies as a function of radial position. In one specific implementation, the susceptor has a 20 mm radius. A wide range of power dissipation profiles are possible, including selective heating near the core and selective heating in the outer shells, as the conductivity profile is varied. Approximately uniform heating is achieved when p is set to be between 2 and 3, for susceptors where the skin depth at r=20 mm is greater than 12 mm (or more generally, where the outer skin depth is greater than 0.6 times the susceptor radius).

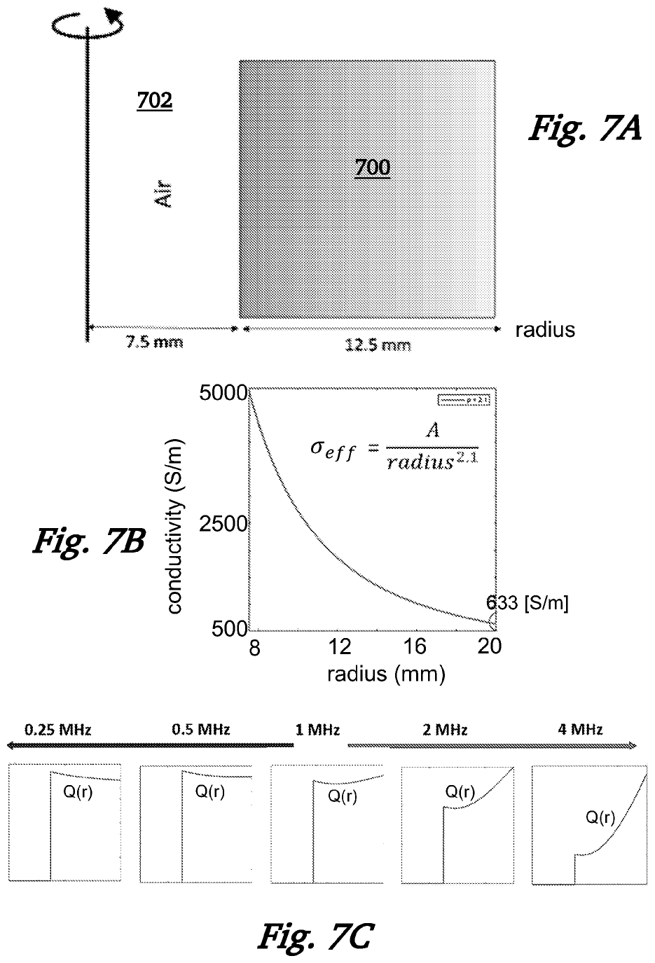

As shown in FIG. 7A, embodiments include a cylindrical susceptor 700 (20 mm outer radius, 7.5 mm inner radius) comprising an air core 702 and a conductivity profile shown in FIG. 7B that varies as 1/r^{2.1}. As shown in FIG. 7C the heating profile can be tuned as a function of frequency, from higher near the core (low frequency) to uniform (medium frequency) to higher near the outer cylinder edge (high frequency).

σ_{eff} and μ_{eff} can also be specified to be anisotropic, for example they can have different values along radial directions versus axial directions. This anisotropy can allow different sets of magnetic coils to heat the susceptor, either independently or in conjunction, to produce different heating profiles. This anisotropy can also be extreme, such that the susceptor appears metallic along one axis and non-metallic along a different access. Along the axis where the susceptor behaves like a non-metallic material, sensing modalities such as MRI or any other RF-based method can be utilized.

Importantly, while σ_{eff} and μ_{eff} can help guide the specification of susceptors that can support high efficiency heating and tailorable volumetric heating profiles, they are homogenized parameters that offer a picture into the macroscopic heating profile within the susceptor, averaged over the detailed susceptor wire layout. To achieve uniform heating within the microscopic wires of the susceptor, specific wire layouts need to be tailored and achieved. The term “microscopic” refers to heating profiles associated with individual wires in the metamaterial unit cell. This is contrary to “macroscopic,” which pertains to the reactor-scale heating profile as specified by the effective metamaterial susceptor conductivity and does not specify the detailed microscopic heating profiles of the system. An example of such as microscopic mesh, which can be achieved using additive manufacturing, is a locally cubic mesh (interconnected wires along the edges of a cube) in which the wires are all at a 45 degree angle relative to axial direction. As another example, the susceptor can have the form of open cell gyroid or triply periodic minimal surface structures, which feature curved metallic elements and no sharp junctions between elements, which can mitigate the presence of heating hot spots. Such structures also serve as high performance mechanical metamaterials, supporting relatively high mechanical strength while operating in high temperature environments with high fluid velocity flows.

σ_{eff} and μ_{eff} can also be co-designed together with the thermal conductivity properties of the heating susceptor volumetric composite, by judicious design of the detailed mesh geometry or by doping the susceptor with different materials. For example, the addition of hBN to the susceptor composite can enhance thermal conductivity of the composite while reducing σ_{eff}. This can further control the heating profile and can specifically enhance heating uniformity.

The large surface area and small porosity of the susceptor ensures low thermal resistance (i.e., heat efficiently transfers to the fluid) and low diffusion resistance (i.e., fluid efficiently diffuses to the susceptor surface for heating) compared to conventional methods. For susceptors functionalized with a catalyst and placed within a tube, the system serves as a chemical reactor and the low thermal resistance (i.e., heat efficiently transfers to the catalyst) and low diffusion resistance (i.e., fluid efficiently diffuses to the catalyst surface) eliminates thermal and mass transport as bottlenecks to residence time. These reactors can operate in the reaction kinetics limit, allowing for very short residence times and therefore extreme process intensification, i.e., reduction of the reactor size by an order of magnitude or more compared to conventional reactors.

Our use of an open mesh network that does not contain enclosed channels features multiple advantages over alternative related schemes, such as microchannel layouts. First, if there is a plug, due to carbon deposition for example, only a small section of the mesh will deactivate. For microchannels, plugs will deactivate the entire channel. Second, the pressure drop through the open mesh network is modest.

The susceptors can function as motionless mixers to help facilitate fluidic mixing, including gases and liquids. Such mixing can be tailored based on the detailed cross section of the susceptor wire geometry without impacting its electromagnetic properties, and more generally can be co-designed with its electromagnetic properties. At high volumetric flow rates, all susceptor mesh layouts will promote turbulent gas flow that enables effective gas circulation and mixing within the full reactor body.

The susceptor can be uncoated, oxidized to support an inert oxide passivation layer, or coated with a separate passivation material layer. In this embodiment, the susceptor can serve as a heater or preheater, heating a gas or liquid with high heat flux transfer.

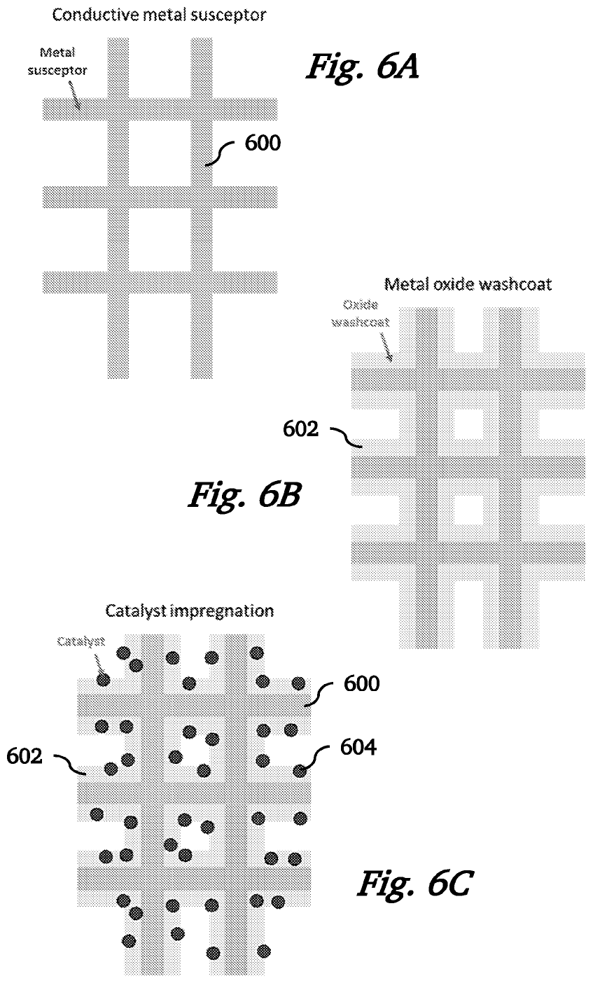

For use in a chemical reactor, the susceptor be interfaced with catalyst materials to perform chemical reactions. Catalyst material can interface with the susceptor in various ways. An oxide support can be wash-coated onto the susceptor and impregnated with catalyst material. For example, FIGS. 6A, 6B, 6C illustrate steps for fabrication of a monolith susceptor with chemical functionality, where FIG. 6A shows a first step where a susceptor 600 comprising a conductive medium (e.g., metal) is manufactured, FIG. 6B shows a step where the susceptor is metal oxide wash-coated with an oxide support 602 such as gamma phase alumina or zirconia, and FIG. 6C shows a step where the oxide support 602 is functionalized with a catalyst 604.

Alternatively, catalyst material can be deposited onto the susceptor using atomic layer deposition, for example with the direct deposition of platinum nanoparticles. In these schemes, heat transfer from the susceptor to catalyst is very efficient, as distance from the susceptor to catalyst is on the order of tens of microns.

In another scheme, fixed bed particles can be added and fill the susceptor void space. In this embodiment, the manufacturing of the susceptor and fixed bed particles are separate, simplifying system manufacturing and allowing the susceptor to be easily recycled by removing and reloading the system with fresh fixed bed material.

The reactor can also include chemically inert material, such as metal or ceramic material, which can store heat through its heat capacity. This inert material can be incorporated through wash-coating or as added fixed bed material. These materials serve as a type of “heat battery” and can transfer heat to a catalyst or the susceptor if power provided to the susceptor is fluctuating, which can happen in the case where the source of electricity is intermittent.

Embodiments can be adapted to a wide range of conductive susceptor materials and susceptor geometries. Materials include 1) Superalloy metal structures made from nickel or iron-based superalloys, for example, which can be inductively heated to very high temperatures of around 1000 C; 2) Other metals, for example steel, stainless steel, aluminum, titanium, Inconel, and copper, can be used for relatively lower temperature applications; 3) Conductive carbon consisting of reticulated vitreous carbon, carbon nanotubes, and/or graphite; 4) Ceramics such as silicon carbide, silicon-silicon carbide.

For structures with uniform effective conductivities, they can have the form of 1) Open cell foams with porosities that vary from the microscale to centimeter scale; 2) Disordered metal lattice made from pressureless sintering of metal fibers. Additives, such as electrically insulating fibers, can be added to create composites with electrical conductivities that are decoupled from the intrinsic metal fiber conductivity and fill fraction. For example, metal superalloy fibers sintered with hBN exhibit relatively reduced electrical conductivity and enhanced thermal conductivity; 3) Regular periodic open cell lattices such as cubic, gyroid, and diamond lattices, triply periodic minimal surface lattices, etc.

For structures with conductivities that vary as a function of position, they can be manufactured in various ways, including 1) Metals and ceramics can be additively manufactured directly through laser sintering or extrusion; 2) A polymer scaffold can be additively manufactured followed by infiltration/conversion to a conductive material, polymer pyrolysis to produce a conductive carbon lattice, or some form of material deposition such as chemical vapor deposition to coat the polymer, followed by polymer removal; 3) Lattices featuring relatively large features (on the order of one millimeter or greater) can be made using various metal mesh weaving and related manufacturing techniques in which metal wires are formed into lattices.

Tests were performed with a 5 PPM cylindrical susceptor sample (1.5″ diameter, 6″ long) made from a reticulated vitreous carbon with a 97% void volume fraction, with porosities of 5 pores per inch (PPI), 10 PPI, and 20 PPI. Impedance measurements of the susceptor and coil inside a magnetic coil indicate high efficiency inductive heating above 1 MHz. At 6.67 MHz, the heating efficiency (susceptor heating/(susceptor+coil heating)) is approximately 95%.

Tests were also performed with cylindrical susceptors comprising a regular open-cell cubic lattice made from additively manufactured Haynes nickel-based superalloy. Two examples of susceptors (1.5″ diameter, 6″ long) were tested, one sample with a lattice pitch of 4 mm and a wire diameter of 800 μm, the other sample with a lattice pitch of 6.5 mm and a wire diameter of 800 μm. Tests confirm that the lattice can be characterized as an effective medium and that the frequencies at which the skin depth of the effective medium is approximately radius/2 are tunable based on lattice geometry. These frequencies are the ideal inductive heating frequencies for each susceptor in a manner that balances volumetric heating with heating efficiency.

Tests were also performed with cylindrical susceptors comprising a wide range of material compositions, including metal felt made from a non-magnetic nickel-based super-alloy, metal felt made from a magnetic iron-based superalloy, metal foam made from a magnetic iron-based superalloy with 16 pores/cm and 90% volume void, metal foam made from a magnetic iron-based superalloy with 16 pores/cm and 95% volume void, metal foam made from a magnetic iron-based superalloy with 8 pores/cm and 95% volume void. In all cases, the susceptors supported an effective AC conductivity response that was tunable based on material composition and lattice geometry.

Embodiments of the present invention may be adapted for use to implement chemical reactions with industrial relevance for which efficient and uniform volumetric heating is essential.

### Hydrocarbon Processing

There are many industrial processes involving the processing of hydrocarbons at high temperatures or the processing of gases at high temperatures to produce hydrocarbons. These processes include steam methane reforming, dry reforming, and tar reforming to produce syngas, steam cracking to break down saturated hydrocarbons into unsaturated hydrocarbons, water gas shift and reverse water gas shift processes, Sabatier reaction to produce methane from carbon dioxide and hydrogen, hydrogen cyanide production from Andrussow oxidation involving the reaction of methane and ammonia with oxygen, and the Fischer-Tropsch process to produce carbon monoxide and hydrogen to liquid hydrocarbons. Catalyst materials include ruthenium, rhodium, nickel, iridium, cobalt, platinum, palladium, iron, copper, and associated alloys.

### Carbon Dioxide Capture, from Air or Flue Streams

Leading technologies for the capture of CO₂ use media that can selectively capture CO₂ at low temperatures and then releasing the CO₂ at higher temperatures using a temperature swing. These media range from amines and carbonate-based sorbents to metal oxide frameworks. The proposed induction heating technique, in which a metamaterial susceptor interfaces with sorbent materials, can enable clean heating with fast heating rates and overall reduced energy cost compared to alternative methods.

Sulfur dioxide capture, in which H2S is removed and converted to hydrogen and sulfur. A promising scheme to remove sulfur dioxide, based on an absorption-regeneration concept, is to react sulfur dioxide with FeS to produce FeS2 and then to release S and to convert FeS2 back to FeS, using steam as a carrier gas. Iron sulfides are electrically conductive, meaning they can be directly heated through inductive heating.

### Flow Chemistries for Organic Synthesis

Flow chemistry, in which chemical reactions are achieved with continuously flowing streams of fluids, have become a standard method for producing organic chemicals and specifically pharmaceuticals. To efficiently heat these reactors, microreactors are used, and more recently, functional inductively heated nanoparticles have been employed. Our scheme based on a metamaterial susceptor features the benefits of microreactors, i.e., excellent heat transfer with high surface area to volumes, customizable heating profiles, and strong mixing in which the metamaterial susceptor functions as a motionless mixer. Furthermore, our concept can be readily utilized in multi-step processes, by placing different susceptors functionalized with different catalysts and heated with different power electronics in series. It also features benefits beyond current microreactors, i.e., is not as susceptible to plugging since the susceptor is an open cell structure, can be readily scaled to arbitrary diameter sizes with much less capital cost, is easier to maintain. Compared to methods based on the inductive heating of particle-based susceptors, our concept does not require separation of particles from the solution upon completion of flow chemistries. Example of relevant flow chemistries include alcohol oxidation, Heck or Suzuki-Miyaura cross-coupling, transfer hydrogenation, dehydration, hydrodeoxygenation, acid-catalyzed isomerization, and amine and amide synthesis. Examples of flow chemistries for the synthesis of pharmaceutical products can be found elsewhere (doi.org/10.1021/acs.oprd.5b00325).

### Preparation of Supported Catalysts

Many supported catalysts require high temperature heating for synthesis and activation, and they also require high temperature heating for operation. The inductive heating of a metamaterial susceptor can be used to directly synthesize and activate catalytic material directly on the susceptor support and also serve to heat the catalyst during reactor operation. Compared to existing methods, the energy requirement for catalyst preparation would be significantly less than the use of a conventional oven. An example of such an application is the growth of copper oxide catalytic structures from a copper-based metamaterial susceptor (doi.org/10.1021/nl1034545), for use in oxidative reaction of hydrocarbons.

### Fluidic Heating

Many applications require the heating of gases or liquids without the need for direct coupling with chemical reactions. These include the heating of fluids for water heaters, heating of various liquids for the food industry, generation of steam from water, and the preheating of gases for use in a chemical reactor. Our concept offers low capital costs and extreme process intensification, which allows the form factor for the heating system to be relatively small. In addition, the specification of metamaterials with no significant hot spots eliminates presence of high local temperature spikes, which is important for applications where temperature spikes can impact food quality.

### Mechanical Energy Conversion Technologies

Many mechanical energy conversion technologies couple the heating of fluids together with concepts in thermodynamics to produce mechanical energy. For example, the heating of gases in a vessel will lead to an increase in gas pressure. Inductive heating of a metamaterial susceptor, and in particular high power pulsed heating (which is readily accessible with solid state power electronics), can lead to very high heat transfer rates and temperature increases in gases. This high heat transfer is particularly aided by the high surface area to volume ratio of the metamaterial. These concepts can be utilized in propulsion devices and be coupled to heat engine concepts based on the Brayton cycle and Rankine cycle, amongst others, to serve in all-electric mechanical systems.

### Syngas and Hydrogen Gas Production

Syngas and hydrogen are the building blocks for many value-added chemicals ranging from ammonia to hydrocarbon fuels. Currently, the most widely used method for producing these gases is the conversion of methane or hydrocarbons using reforming⁷. Here, hydrocarbons react with steam over a catalyst at high temperatures to produce syngas. These catalyst materials include ruthenium, rhodium, nickel, iridium, cobalt, platinum, palladium, iron, copper, and associated alloys, and they are all electrically conductive. Mesh susceptors made in part or entirely from these catalytic materials can directly heat them to high temperatures. Inductive heating can also be adapted to dry reforming reactions, in which carbon dioxide and methane react to produce syngas.

### Steam Cracking

Steam cracking is a high temperature process in which saturated hydrocarbons are broken down into smaller and often unsaturated hydrocarbons. Examples of the process include the production of ethylene from ethane and the production of propylene from propane. Steam cracking requires the rapid heating of the gases to high temperatures, typically above 800 degrees Celsius, and maintains this high temperature for endothermic reactions. It is then followed by rapid quenching to mitigate undesirable secondary reactions. Conductive mesh susceptors can serve as high area, high temperature heating elements that can efficiently provide heat for steam cracking. In general, the excellent thermal contact between volumetric susceptors and fluids is ideal for reactor systems that require low resistance times and low thermal resistance.

### Limestone Decomposition into Lime

Lime (i.e., calcium oxide) is a chemical used industrially to manufacture everything from concrete to gas sorbents⁸. It is produced through the decomposition of calcium carbonate at temperatures above 840 degrees Celsius, releasing carbon dioxide in the process. A mesh susceptor interfaced with limestone powder can directly heat these materials and reduce them to lime. A mesh susceptor can also be built into the reactor walls themselves, such as a rotating kiln, and heat transfer can occur through the reactor walls. With this approach, carbon dioxide released from limestone can be directly captured from the flue gas at high purity without need of gas separation, since nitrogen-rich gases are not used for heat transfer.

### Cement and Ceramic Manufacturing

The manufacturing of cement and ceramics involves the heating of a mixture of metal oxides (alumina, calcium oxide, etc.) and other additives to high temperatures Currently, this heating is almost exclusively done using radiative heat transfer from a combusted hydrocarbon source, releasing carbon dioxide. A mesh susceptor built within the reactor walls or placed within the reactor interior can provide heat for these reactions. For volumetric mesh susceptors within the reactor interior, the susceptors will comprise materials and designs that are mechanically sturdy at high processing temperatures.

### Materials Processing through Pyrolysis

Pyrolysis involves the thermal decomposition of materials in an inert atmosphere. It is used extensively in industry to convert hydrocarbons to fuels. For example, it is used to convert methane to hydrogen and carbon without the release of carbon dioxide, coke, liquid hydrocarbon and gases from coal, bio-oil, bio-char and syngas from biomass⁹, ethylene and propylene from various hydrocarbons, and liquid oil, wax, char and gases from plastic waste. Mesh susceptors can enable clean, efficient, and fast heating of the media to controllable temperatures, enabling fast throughput and reduced reactor sizes. In the case of processes such as methane pyrolysis, the susceptors can serve as both a heating element and catalyst.

### Hydrogen Sulfur Capture and Utilization

Hydrogen sulfide can be removed from a flue or reforming gas stream and converted to hydrogen and sulfur. Hydrogen sulfide, based on a reaction-regeneration scheme, can react with iron or iron sulfide10 compound to form hydrogen and solid products of iron sulfide or iron disulfide compounds. Upon heating of the solid products, sulfur can be released while iron or iron sulfide compound is regenerated. Iron and Iron sulfides are electrically conductive; that is, they can be directly heated through inductive heating. A similar heating principle can be applied to other materials than Fe based material for this reaction scheme.

1. A high temperature reactor comprising:
a reactor wall defining an interior of the reactor;
a conductive susceptor composed of interconnected conductive elements distributed throughout a volumetric region within the interior of the reactor and adapted to heat the volumetric region;
electromagnetic coils surrounding the conductive susceptor and adapted to produce an electromagnetic field that inductively couples to the conductive susceptor;
a power supply connected to the electromagnetic coils and adapted to produce AC electrical power at a predetermined operating frequency.

2. The high temperature reactor of claim 1 wherein spatial variations within the conductive susceptor (i.e., size scale of and spacing between the interconnected conductive elements) are substantially smaller than the free space wavelength of the electromagnetic field.

3. The high temperature reactor of claim 1 wherein the predetermined operating frequency is above 1 MHz.

4. The high temperature reactor of claim 1 wherein the interconnected conductive elements are arranged in an ordered structure.

5. The high temperature reactor of claim 1 wherein the interconnected conductive elements are arranged in a disordered structure.

6. The high temperature reactor of claim 1 wherein the interconnected conductive elements are densely packed.

7. The high temperature reactor of claim 1 wherein the conductive susceptor has spatially uniform conductivity.

8. The high temperature reactor of claim 1 wherein the conductive susceptor has spatially inhomogeneous conductivity.

9. The high temperature reactor of claim 1 wherein the interconnected conductive elements form a microwire mesh, metal wool, metal felt, regular metal mesh, metal pipes, tubes, or baffles.

10. The high temperature reactor of claim 1 wherein the reactor wall is composed mostly of a non-conductive material such as plastic, glass, or a refractory ceramic.

11. A chemical reactor for inductive heating, the chemical reactor comprising:
a reactor wall defining an interior of the reactor, wherein the reactor wall is composed substantially of a non-conductive material;
a susceptor composed of a conductive electromagnetic metamaterial; wherein the susceptor has interconnected conductive elements in an open cell 3D structure; wherein the susceptor is distributed throughout a volumetric region within the interior of the reactor;
electromagnetic coils surrounding the susceptor and adapted to produce an electromagnetic field that inductively couples to the susceptor;
a power supply connected to the electromagnetic coils and adapted to produce AC electrical power at a predetermined operating frequency, thereby generating the electromagnetic field having a predetermined wavelength causing inductive heating of the susceptor;
wherein susceptor has a predetermined effective AC conductivity response as a predetermined function of position within the volumetric region at the predetermined operating frequency.

12. The chemical reactor of claim 11 wherein the susceptor is distributed throughout multiple volumetric regions within the interior of the reactor.

13. The chemical reactor of claim 11 wherein the effective AC conductivity is a predetermined function of position within the volumetric region.

14. The chemical reactor of claim 11 wherein susceptor comprises a magnetic material and has a predetermined effective permeability response as a predetermined function of position within the volumetric region at the predetermined operating frequency.

15. The chemical reactor of claim 11 wherein the predetermined function of position is a function of radial position within a cylindrical region.

16. The chemical reactor of claim 11 wherein the predetermined function of position is a function of axial position within a cylindrical region.

17. The chemical reactor of claim 11 wherein the predetermined function of position is a function of axial and radial positions within a cylindrical region.

18. The chemical reactor of claim 11 wherein the predetermined function of position is selected to produce spatially uniform heating within the volumetric region.

19. The chemical reactor of claim 11 wherein the predetermined function of position is a constant function of position.

20. The chemical reactor of claim 11 wherein the predetermined function of position is a variable function of position.

21. The chemical reactor of claim 11wherein the predetermined function of position and predetermined operating frequency are selected based on a predetermined diameter of the chemical reactor in order to optimize heating uniformity and efficiency.

22. The chemical reactor of claim 11 wherein the susceptor has thickness within a factor of 10, or more preferably a factor of 3, of a skin depth of penetration of the magnetic fields within the susceptor at the predetermined operating frequency.

23. The chemical reactor of claim 11 wherein a predetermined diameter of the volumetric region is within a factor of 10, or more preferably, a factor of 3, of a skin depth of penetration of the magnetic fields within the susceptor at the predetermined operating frequency.

24. The chemical reactor of claim 11 wherein the effective AC conductivity is a predetermined constant function of position within the volumetric region, and wherein the product of the predetermined diameter of the volumetric region and the predetermined operating frequency is within a factor of 10, or more preferably, a factor of 3, of the reciprocal of the square of the predetermined diameter of the volumetric region.

25. The chemical reactor of claim 11 wherein the electromagnetic coil has a length that is at most 1/10 of a wavelength corresponding to the predetermined operating frequency.
